(19) United States
(12) Patent Application Publication
(10) Pub. No.: US 2012/0196022 A1
(43) Pub. Date: Aug. 2, 2012

(54) Corn Fiber Gum Composites as a Thickener

(76) Inventors: Madhav P. Yadav, North Wales, PA (US); Hongbin Zhang, Shanghai (CN); Tu Luan, Shanghai (CN); Lijiao Wu, Shanghai (CN)

(21) Appl. No.: 13/352,623

(22) Filed: Jan. 18, 2012

(30) Foreign Application Priority Data
Feb. 2, 2011 (CN) 201110041932.7

(51) Int. Cl. A23L 1/05; A23L 1/0522; A23L 1/0534; A23L 1/0532; A23L 1/056; A23L 1/0526; A23L 1/0528; A23L 1/0524

(52) U.S. Cl. 426/575; 426/573; 426/578; 426/577

(57) ABSTRACT

Disclosed herein is a composition (composite thickener) that generally contains about 1 wt % to about 99 wt % (e.g., 1 wt % to 99 wt %) corn fiber gum (CFG) and about 99 wt % to about 1 wt % (e.g., 99 wt % to 1 wt %) polymer thickener. The polymer thickener may be anionic polysaccharides, cationic polysaccharide, neutral polysaccharides, or mixtures thereof. When applied to aqueous solutions, CFG produced synergistic effects with one or more polymer thickener components and showed a superior thickening effect than individual CFG and other polymer thickener components.

### REFERENCE TO RELATED APPLICATION

This application claims the benefit of a Chinese patent application filed on 2 Feb. 2011 (reference number 201110041932.7) which is incorporated herein by reference in its entirety.

### BACKGROUND OF THE INVENTION

Disclosed herein is a composition (e.g., composite thickener) that generally contains about 1 wt % to about 99 wt % (e.g., 1 wt % to 99 wt %) corn fiber gum and about 99 wt % to about 1 wt % (e.g., 99 wt % to 1 wt %) polymer thickener. The polymer thickener may be anionic polysaccharides, cationic polysaccharides, neutral polysaccharides, or mixtures thereof.

Thickener, also known as tackifier, or food gum when applied to food, is the term applied to substances which increase the viscosity of a system so as to maintain it in a uniform and stable suspension or emulsions state, or form a gel. Current commercial thickeners are either chemically synthesized or are natural polysaccharides or derivatives thereof. Natural polysaccharides can be divided into animal gums, plant gums, and microbial gums. Thickeners, when applied to products, can quickly increase viscosity and improve stability efficaciously, so they are widely used in foods, coatings, adhesives, cosmetics, detergents, rubber, water treatment, printing and dyeing, oil exploitation, construction, agriculture, medicine, etc. The demand to add thickener to products has increased unceasingly, plus new thickeners are being developed constantly as their usage is growing. Composite's thickeners which produce superior effects and which allow lower amounts to be used have tremendous market potential. In recent years, development and applications of composites thickener has been an industry hotspot.

Corn fiber gum (CFG) is an alkaline hydrogen peroxide extract of corn fiber, which is an abundant and low-valued by-product of the corn kernel wet milling process (Yadav, M. P., et al., Food Hydrocolloids, 21: 1022-1030 (2007)). Corn fiber is composed of the fibrous parts of corn kernel pericarp and endosperm cell-wall. Commercial corn dry grinding process is also a source of corn fiber. Corn fiber obtained from the dry milling industry is usually referred to as corn bran or corn, pericarp fiber. CFG has a highly branched structure with a β-(1-4)-xylopyranose backbone and α-L-arabinofuranose residues as side chains on both primary and secondary hydroxyl groups, with some D-glucuronic acid residues linked to the O-2 position of the xylose residue of the backbone and galactose, and some xylose residues attached to the arabinofuranosyl branches (FIG. 1). It has the following glycosyl composition: D-xylose (48-54%), L-arabinose (33-35%); galactose (7-1.1%), and glucuronic acid (1-6%) (Yadav, M. P., et al., Journal of Agricultural and Food Chemistry, 56: 4181-4418 (2008); Doner, L. W., et al., Cereal Chemistry, 75(4): 408-411 (1998); Hespell, R. B., Journal of Agricultural and Food Chemistry, 46(7): 2615-2619 (1998); Saulnier, L., et al., Carbohydrate Polymers, 26(4): 279-287 (1995); Sugawara, M., et al., Starch-Stärke, 46(9): 335-337 (1994); Whistler, R. L., and J. N. BeMiller, Journal of the American Chemical Society, 78(6): 1163-1165 (1956)). Like gum arabic, although CFG contains some hydrophobic proteins, it can be regarded as an anionic, highly branched polysaccharide with a long xylopyranose backbone (Yadav, M. P., et al., Cereal Chemistry, 87(2): 89-94 (2010); Yadav, M. P., et al., Carbohydrate Polymers, 81(2): 476-483 (2010)).

CFG shows a good emulsification ability for oil-in-water emulsions systems which may be due to the presence of protein and lipid on it (Yadav et al., 2009). It has several useful properties, e.g., adhesive, thickening, and stabilizing (Wolf, M. J., et al., Cereal Chemistry, 30: 451-470 (1953)) and film forming and emulsifying (Mikkonen, K. S, et al., Bioresources, 3(1) 178-191 (2008); Woo, D. H., Food Science and Technology, 10(4): 348-353 (2001)).

Although CFG by itself may be used as a thickener (Yadav, M. P., et al., Food Hydrocolloids, 23(6): 1488-1493 (2009)), it has a limited thickening effect due to its low viscosity and the required amount of thickener will be large. Possible synergistic viscosity increase of CFG with aqueous solutions of different polysaccharides or their derivatives would be important to broaden its applications for many food and non-food uses. Most of the current work related to CFG are focused on the aspects of its isolation, structural characterization; and emulsifying ability (Doner et al., 1998; Singh, V., et al., Cereal Chemistry, 77(5): 560-561 (2000); Yadav, M. P., et al., Cereal Chemistry, 84(2): 175-180 (2007); Yadav, M. P., et al., Journal of Agricultural and Food Chemistry, 55(15): 6366-6371 (2007); Yadav, M. P., et al., Journal Agricultural and Food Chemistry, 56(11): 4181-4187 (2008); Yadav, M. P., et al., Cereal Chemistry, 87(2): 89-94 (2010); Yadav, M. P., et al., Food Hydrocolloids, 23(6): 1488-1493 (2009); Yadav, M. P., et al., Journal of Agricultural and Food Chemistry, 55(15): 6366-637.1 (2007); Yadav, M. P., et al., Journal of Agricultural and Food Chemistry, 56(11): 4181-4187 (2008); Yadav, M. P., et al Carbohydrate Polymers, 81(2): 476-483 (2010)).

Thus it is important to find viscous synergism in mixtures of CFG with other compounds. We utilized the following three charged or uncharged polysaccharides: (a) an anionic polysaccharide (e.g., hyaluronan, HA), (b) a cationic polysaccharide (e.g., chitosan, CTS), and (c) a neutral polysaccharide (e.g., methylcellulose, MC). The degree of viscous synergism of CFG at different concentration with these three kinds of polysaccharides was quantified, and the influencing factors and the possible mechanism are discussed below

### SUMMARY OF THE INVENTION

Disclosed herein is a composition (e.g., composite thickener) that generally contains about 1 wt % to about 99 wt % (e.g., 1 wt % to 99 wt %) corn fiber gum and about 99 wt % to about 1 wt % (e.g., 99 wt % to 1 wt %) polymer thickener. The polymer thickener may be anionic polysaccharides, cationic polysaccharides, neutral polysaccharides, or mixtures thereof.

This summary is provided to introduce a selection of concepts in a simplified form that are further described below in the detailed description. This summary is not intended to identify key features or essential features of the claimed subject matter, nor is it intended as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows the structure of corn fiber gum (CFG).

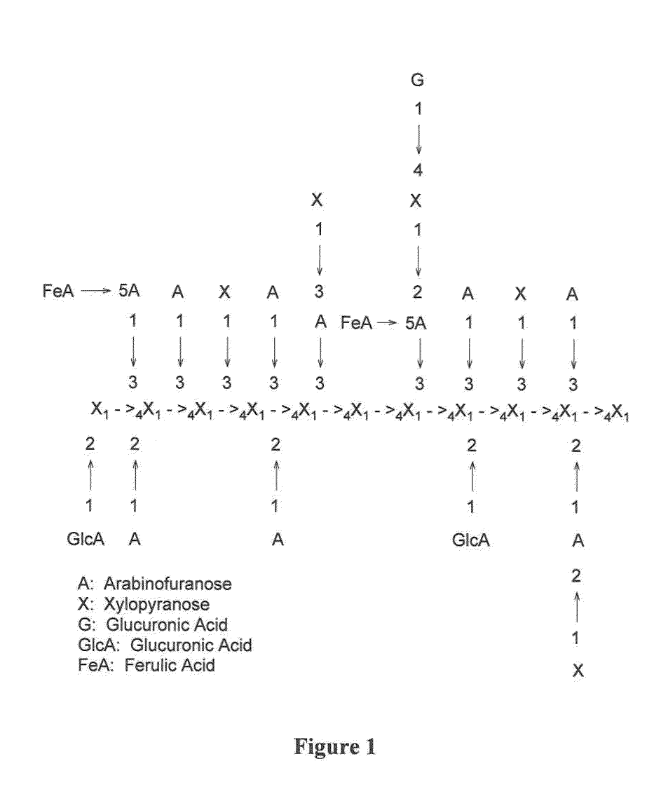

FIG. 2 shows the steady state shear viscosity of aqueous solutions of 2% CFG composite thickener obtained from Example 1 and the comparison of the thickening effect at 25° C. as described below.

FIG. 3 shows the steady state shear viscosity of aqueous solutions of 4% CFG composite thickener obtained from Example 2 and the comparison of the thickening effect at 25° C. as described below.

FIG. 4 shows the steady state shear viscosity of aqueous solutions of 7% CFG composite thickener obtained from Example 3 and the comparison of the thickening effect at 25° C. as described below.

FIG. 5 shows the steady state shear viscosity of aqueous solutions of 2% CFG composite thickener obtained from Example 4 and the comparison of the thickening effect at 25° C. as described below.

FIG. 6 shows the steady state shear viscosity of 2% CFG composite thickener (in 0.5% acetic acid) obtained from Example 5 and the comparison of the thickening effect at 25° C. as described below.

FIG. 7 shows steady shear viscosities of CFG/HA mixtures at three different concentrations and corresponding individual CFG solutions at 25° C. as described below.

FIG. 8 shows the molecular weight calibration curves of (A) CFG (top figure) and (B) HA (bottom figure), superimposed on their LALS, RALS, VIS and RI chromatograms from SEC system as described below.

FIG. 9 shows schematic model for intermolecular binding between CFG and HA as described below.

FIG. 10 shows the viscous synergism index (Iᵥ) as a function of the shear rates and the compositions of mixed HA/CFG solution expressed in term of the Φ_{CFG} (25° C.) as described below.

FIG. 11 shows steady shear viscosities of (a) CFG/CTS blends and corresponding individual solutions and (b) CFG/MC blends and corresponding individual solutions as described below.

### DETAILED DESCRIPTION OF THE INVENTION

We have found that, when applied, to aqueous solutions, CFG produced synergistic effects with one or more polymer thickener components and provided a superior thickening effect than individual CFG and polymer thickener components. The composition generally contains about 1 wt % to about 99 wt % (e.g., 1 wt % to 99 wt %) corn fiber gum and about 99 wt % to about 1 wt % (e.g., 99 wt % to 1 wt %) polymer thickener, preferably about 50 wt % to about 90 wt % (e.g., 50 wt % to 90 wt %) corn fiber gum and about 50 wt % to about 10 wt % (e.g., 50 wt % to 10 wt %) polymer thickener. The polymer thickener may be anionic polysaccharides, cationic polysaccharides, neutral polysaccharides, or mixtures thereof.

The anionic polysaccharides are charged carbohydrate polymers and generally include hyaluronan, sodium alginate, pectin, carrageenan, xanthan gum, chondroitin sulfate, gum arabic, gum karaya, gum tragacanth sodium carboxymethylcellulose, or mixtures thereof.

The cationic polysaccharides are positively charged carbohydrate polymers and generally include chitosan, cationic guar gum, and cationic hydroxyethylcellulose.

The neutral polysaccharides are uncharged (non-ionic) carbohydrate polymers and generally include methyl cellulose, guar gum, locust bean gum, konjac gum, agarose, starch, ethyl cellulose, hydroxyl ethyl cellulose, hydroxypropyl cellulose, methyl hydroxyl ethyl cellulose, methyl hydroxypropyl cellulose, or mixtures thereof.

Preferrably the polymer thickener is hyaluronan, chitosan, methyl cellulose, or mixtures thereof.

Also disclosed are preparation methods of the above CFG composites thickener. CFG composites thickener is prepared by mixing CFG with polymer thickeners and adding to the system to be thickened, or CFG and polymer thickener are added to the system to be thickened separately.

Unless defined otherwise, all technical and scientific terms used herein have the same meaning as commonly understood by one of ordinary skill in the art to which the invention belongs. The term “about” is defined as plus or minus ten percent; for example, about 100° F. means 90° F. to 110° F. Although any methods and materials similar or equivalent to those described herein can be used in the practice or testing of the present invention, the preferred methods and materials are now described.

The following examples are intended only to further illustrate the and are not intended to limit the scope of the invention as defined by the claims.

### EXAMPLES

Materials: HA (hyaluronan) was obtained from Freda Biochemistry (China) in the form of sodium salt, it originated from bacterial fermentation. The MC (methylcellulose) sample, with the commercial name SM4000, was purchased from Shin-Estu Chemical Co. Ltd., Japan; according to the manufacturer; this MC has an average degree of substitution (DS) 1.8 and weight average molecular weight (M_{w}) 3.8×10⁵ (determined by light scattering method). CTS (chitosan; viscosity: 50˜800 mPa s, degree of deacetylation: 80˜95) was purchased from Sinopharm Chemical Reagent Co., Ltd (China). All the other chemicals used in the study were purchased from Sinopharm Chemical Reagent Co., Ltd (China) and were of analytical grade.

Solutions preparation: The powder of CFG, HA and MC samples were dispersed in distilled water and then mixed on a roller mixer for 24 hours. The dispersion of MC sample was transferred to a refrigerator at 4° C. until it completely solubilized as it did not dissolve well at room temperature. The CTS solution was prepared in 1% acetic acid. The pH value of the CFG solution was measured at room temperature using PHS-3TC pH Meter (Shanghai Tianda Instrument Co., Ltd, China). For mixed solutions, the CFG solutions with different concentrations. Were mixed with other polysaccharide solutions (at a fixed concentration of 10 mg/mL) at a volume ratio of 1:1 by gently mixing on a roller mixer.

Size exclusion chromatography (SEC): CM, HA and their mixtures were characterized using a Viscotek TDA 305 instrument (Malvern Instruments, US) equipped with two Viscotek A6000M columns and analyzed with light scattering (LALS, 7 RALS, 90°), refractive index (RI) and online viscometer (VIS) detectors. The concentration of CFG and HA were 2 and 0.5 mg/mL, respectively. The experimental conditions: consisted of 0.15 M NaNO₃ as mobile phase, temperature 30° C., 0.7 mL/min flow rate, and 100 μl injection volume. Data were collected and analyzed by OmniSEC software.

Rheological measurements: The rheological measurements were carried out using a rotational rheometer AR G2 (TA Instruments, USA) with a 2°1′8″ cone plate geometry (60 mm in diameter and 58 μm in gap). The temperature was regulated by a circulating water bath using peltier system. A thin layer of low-viscosity silicone oil was placed on the periphery surface of the solution held between the plates to reduce the evaporation of water from the samples during the measurement. Steady shear viscosities were measured over a shear rate range of 0.01-1000 s⁻¹ at 25° C. Shear steady state was assumed to be attained when the variation of torque was less than 5% throughout three consecutive sampling periods (20 s). The maximum point time was set as 6 minutes.

### Example 1

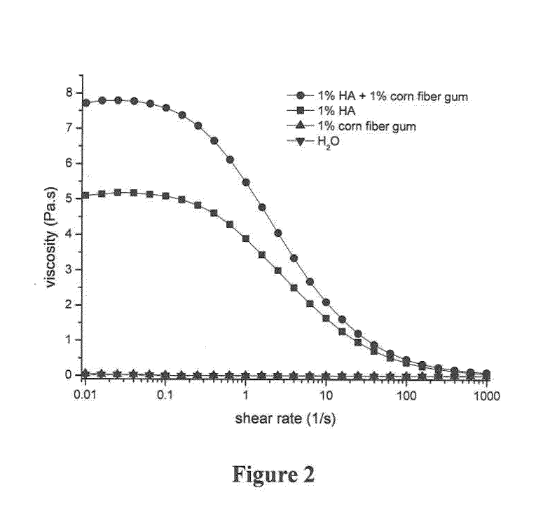

0.2 g CFG and 0.2 g sodium hyaluronate (HA, polyanion) were mixed to prepare the CFG composite thickener. The steady state shear viscosity of aqueous solutions of 2% CFG composite thickener was measured by TA AR-G2 rotational rheometer and the result is shown in FIG. 2 (the viscosity, η₁₀, at 10 s⁻¹, was 2.111 Pa s). FIG. 2 shows that the thickening effect of CFG composite thickener for water was surprisingly superior than individual CFG and HA. The thickening effect was evaluated by comparing the η₁₀. The η₁₀ (2.111 Pa s) of composite added solution was surprisingly higher (about 28%) than the sum of the η₁₀ (0.005 Pa s) of individual CFG solution added and η₁₀ (1.649 Pa s) of individual HA solution added.

### Example 2

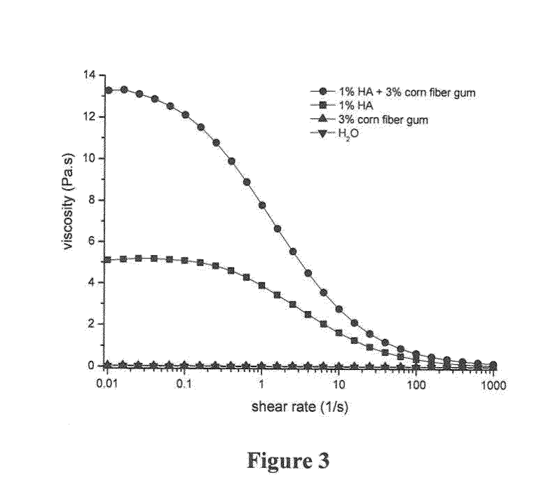

0.6 g CFG and 0.2 g were mixed to prepare the CFG composite thickener. The steady state shear viscosity of aqueous solutions of 4% CFG composite thickener was measured by TA AR-G2 rotational rheometer and the result is shown in FIG. 3 (the η₁₀ was 2.789 Pa s). FIG. 3 shows that the thickening effect CFG composite thickener for water was surprisingly, superior than individual CFG and HA. The thickening effect was evaluated by comparing the η₁₀. The η₁₀ (2.789 Pa s) of composite added solution was surprisingly higher (about 66%) than the sum of the η₁₀ (0.028 Pa s) of individual CFG solution added and η₁₀ (1.649 Pa s) of individual HA solution added.

### Example 3

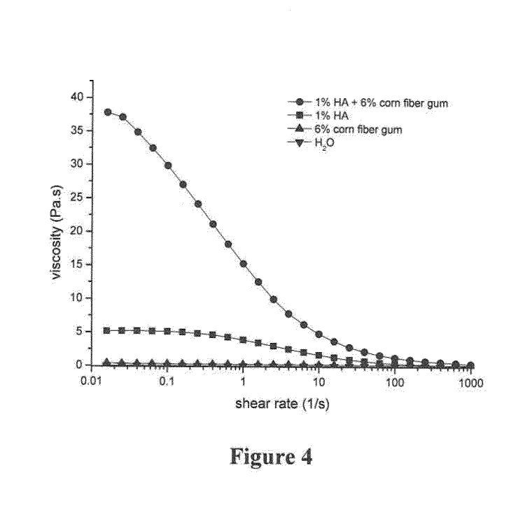

1.2 g CFG and 0.2 g HA were mixed to prepare the CFG composite thickener. The steady state shear viscosity of aqueous solutions of 7% CFG composite thickener was measured by TA AR-G2 rotational rheometer and the result is shown in FIG. 4 (the η₁₀ was 4789 Pa s). FIG. 4 shows that the thickening effect of CFG composite thickener for water was surprisingly superior than individual CFG and HA. The thickening effect was evaluated by comparing the η₁₀. The η₁₀ (4.780 Pa s) of composite added solution was surprisingly higher (about 162%) than the sum of the η₁₀ (0.179 Pa s) of individual CFG solution added and η₁₀ (1.649 Pa s) of individual HA solution added.

### Example 4

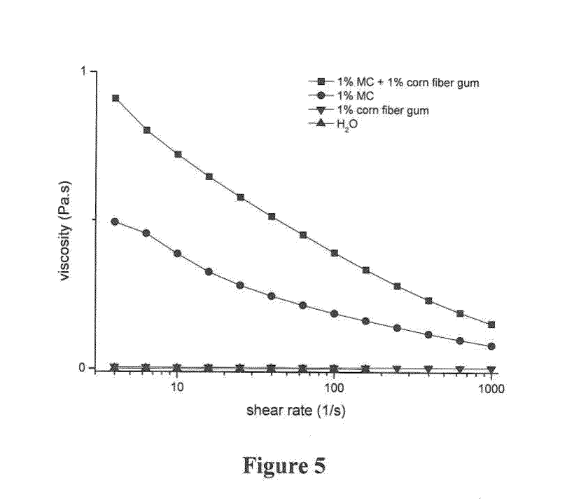

0.2 g CFG and 0.2 g methyl cellulose (MC, neutral polymer) were mixed to prepare the CFG composite thickener. The steady state shear viscosity of aqueous solutions of 2% CFG composite thickener was measured by TA AR-G2 rotational rheometer and the result is shown in FIG. 5 (the η₁₀ was 0.721 Pa s). FIG. 5 shows that the thickening effect of CFG composite thickener for water was surprisingly superior to individual CFG and MC. The thickening effect was evaluated by comparing the η₁₀. The η₁₀ (0.721 Pa s) of composite added solution was surprisingly higher (about 83%) than the sum of the η₁₀ (0.005 Pa s) of individual CFG solution added and η₁₀ (0.388 Pa s) of individual MC solution added.

### Example 5

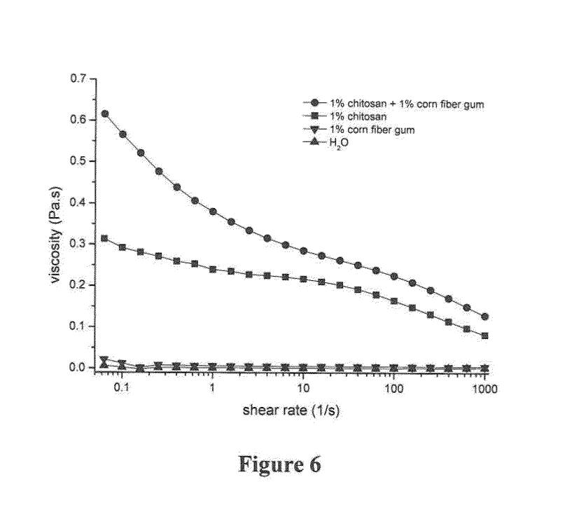

0.2 g CFG and 0.2 g chitosan (polycation) were mixed to prepare the CFG composite thickener. The steady state shear viscosity of aqueous solutions of 2% CFG composite thickener in 0.5% acetic acid was measured by TA AR-G2 rotational rheometer and the result is shown in FIG. 6 (the η₁₀ was 0.287 Pa s). FIG. 6 shows that the thickening effect of CFG composite thickener for water was surprisingly superior than individual CFG and chitosan. The thickening effect was evaluated by comparing the η₁₀. The η₁₀ (0.287 Pa s) of composite added solution was surprisingly higher (about 29%) than the sum of the η₁₀ (0.005 Pa s) of individual CFG solution added and η₁₀ (0.218 Pas) of individual chitosan solution added.

Results and discussion: The color of aqueous solution of CFG and CFG/HA mixtures were light yellow and yellow respectively. The aqueous solution of HA was totally transparent while the CFG solution was slightly cloudy. The pH of a 10 mg/mL CFG solution was 5.94, showing an acidic nature which, without being bound by theory, was probably due to the pretence of glucuronic acid on its backbone. Similar to CFG/HA solution, CFG/CTS and CFG/MC aqueous solutions were also yellow and non-transparent, but CTS and MC, solutions were transparent. In addition, no phase separation in the solutions of these polymers mixtures was seen after storage at 4° C. for one week.

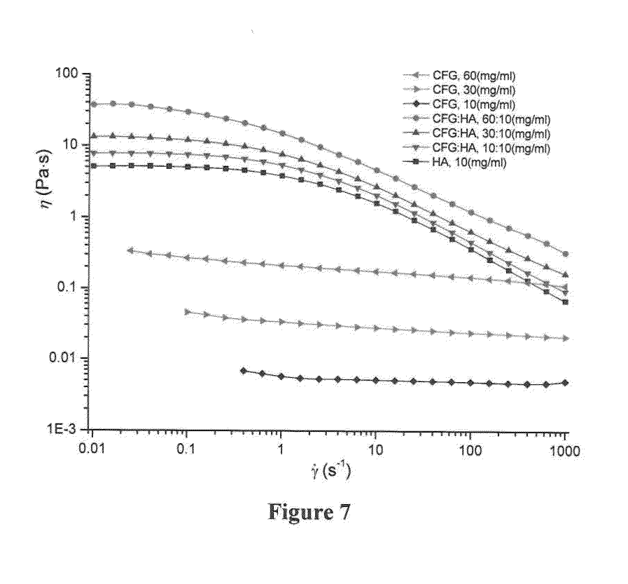

FIG. 7 shows the effect of shear rate (\dot{γ}) on the steady shear viscosities (η) of CFG/MC mixtures at three different CFG concentrations and corresponding individual CFG solutions at 25° C. It was found that the steady shear viscosities of CFG solutions at different concentrations were almost independent of the shear rate. In CFG, no obvious shear thinning phenomenon, where the steady shear viscosity decreases with increasing shear rate, was observed even at a very high shear rate of up to 1000 s⁻¹. This revealing CFG's Newtonian fluid behaviour, where the steady shear viscosity is independent of the shear rate. Moreover, the steady shear viscosities of CFG solutions increased with increased concentration of CFG; but the steady shear viscosities were as low as about 0.3 Pa s even at a relatively high concentration of 60 mg/mL, indicating a nature of low viscous solution. The low viscosity feature of CFG solutions was a good indication of its much branched structure. In CFG/HA mixtures, shear thinning behaviour similar to that of the individual HA solution was observed, indicating dominance of its rheological properties by HA. However, it was surprisingly found that the viscosities of CFG/HA mixtures were much higher than the algebraic sum of their individual viscosity, showing a significant viscous synergism.

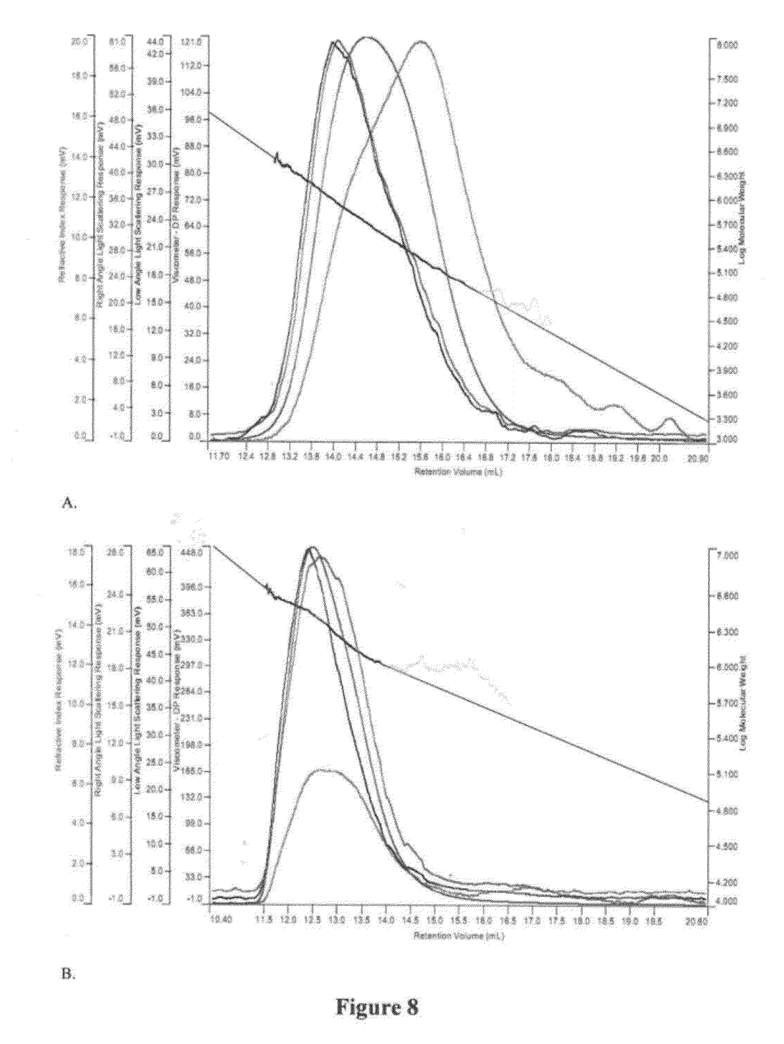

The elution profiles (superimposed chromatograms) of CFG and HA from SEC monitored with LALS (7°), RALS (90°), VIS, and RI are shown in FIG. 8. CFG had a very broad molecular weight distribution which ranged from about 6×10⁴ to 3×10⁶ Da. Table 1 shows the weight average molecular weight M_{w}, polydispersity index M_{w}/Mₙ, z-average radius of gyration R_{g,z}, intrinsic-viscosity [η] and Mark-Houwink parameter a of CFG and HA. The molecular features of CFG differed from HA, as the later possessed flexible chain structure with a large molecular size and intrinsic viscosity. CFG had a high polydispersity and low intrinsic viscosity in comparison to HA solution (Table 1), which was in good agreement with the graph shown in FIG. 7. In addition, a low Mark-Houwink exponent α (0.471) clearly indicated that the CFG molecules are of relatively compact conformation.

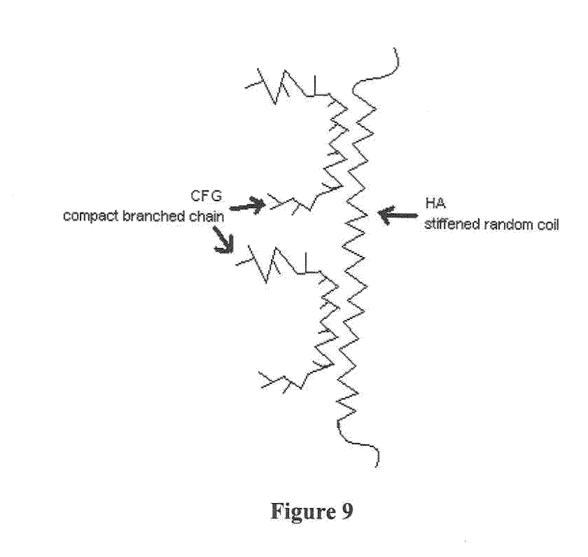

Without being bound by theory: The molecular architecture and the size of the polymers may not be the predominant factors for the viscous synergism seen in CFG/HA mixtures we studied. We found an antagonistic decrease in viscosity of HA mixtures with either a small molecular weight surfactant (e.g., sodium dodecyl sulfate), or a mid-size dentrimer (e.g., polyamidoamine) or a macromolecule (e.g., gum arabic) (data not shown). It is also likely that a high polydispersity and a compact conformation of CFG molecules were not effective factors for viscosity synergism. At this point, it is reasonable to speculate that strong interactions between CFG and HA macromolecules may lead to a conjugate formation between their chains. Such conjugate formation between CFG and HA will increase stiffness in HA chains, consequently increasing the viscosity of the mixture. CFG molecules were highly branched and compact (Table 1), but the HA chain is a stiffened random coil polymer (Luan T., et al., Polymer; 52(24): 5648-5658 (2011)). We assumed that the arabinofuranose side chains of CFG align (fully or alternately) on one side of the xylan backbone leaving the “smooth side” (side without arabinofuranose chains) to closely attach to HA chain as shown in FIG. 9. A large number of hydroxyl groups present in CFG's backbone and carboxyl and acetamido groups in HA chains come together forming an intermolecular hydrogen bonding. Further, studies are in progress to more clearly elucidate the synergistic mechanism of CFG/HA aqueous mixture.

In order to describe the variation in the rheological properties of CFG, HA and their mixtures under steady shear, the rheological profiles from FIG. 7 were fitted to the power law Equation 1 (Hernandez, M. J., et al., Food Science and Technology International, 7(5): 383-391 (2009)):

η=K\dot{γ}ⁿ⁻¹ (1)

where η is the steady shear viscosity (Pa s), \dot{γ} is the shear rate (s⁻¹), K is the consistency index (Pa sⁿ), and n is the flow behavior index (dimensionless). The power law provided good fittings for the various curves in FIG. 7 with coefficient of determination R²>0.99 (lower fitting limit 1 s⁻¹). This model gives opportunity to study the effect of concentration increase on the consistency index (K) and flow behavior index (n) of samples. Table 2 shows the consistency coefficient (K), flow behavior index (n), and corresponding determination coefficient (R²) of individual CFG and HA, and their mixed solutions with various CFG weight fractions (Φ_{CFG}) under various shear rate (25° C.). CFG/HA mixed solution showed a pseudoplastic flow behavior (n value much less than 1) similar to individual HA solution, while the solutions of CFG at all different concentrations clearly showed their typical Newtonian-flow behavior (n close to 1) (Table 2). Moreover, the n values of the mixed HA/CFG solutions were smaller than indiVidual HA solution, showing stronger shear-thinning characteristic. All the CFG/HA mixed solutions had greater K values than individual polymer solution, which increased with increasing CFG concentration, showing a very remarkable synergistic viscosity behavior.

The Cross model (El Ghzaoui, A., et al., Langmuir, 17(5): 1453-1456 (2001)) was used to precisely fit the most general pseudoplastic behavior of the polymer solutions. According to this model, four characteristic parameters representative of the pseudoplastic (shear thinning) behavior of a polymer solution were obtained by the formula

$$σ = [ {η}_{∞} + \frac{{η}_{0} - {η}_{∞}}{1 + {( λ γ )}^{p}} ] \dot{γ} \qquad ( 2 )$$

where η₀ is the zero shear viscosity corresponding to the first Newtonian region, η_{∞} is the infinity shear viscosity, p is the shear rate index characterizing the shear thinning properties of the polymer solutions, and λ is a time parameter corresponding to the inverse ratio of the critical shear rate i\dot{γ}₀, for which the transition between Newtonian and non-Newtonian behavior occurs. The λ parameter may be considered as being the longest relaxation time of the Rouse spectrum for a given polymer solution. Table 3 shows the fitting parameters of the Cross model. Both η₀ and λ of CFG/HA mixed aqueous solutions increased with increasing CFG concentration (Table 3). All of the samples with the higher CFG concentration had lower \dot{γ}₀ value, indicating more pronounced pseudoplastic character. These finding were in good agreement with the results obtained from the power law model as explained above.

As viscosity of a solution depends both on concentration, and shear rate, the parameter quantifying viscous synergism will also be dependent on these variables. Out of several kinds of viscosity synergism index (Dolz, M., et al., Journal of Pharmaceutical Sciences, 84(6): 728-732 (1995); Jimenez, M. M., et al., Chemical & Pharmaceutical Bulletin, 55(8): 1157-1163 (2007); Kaletunc-Gencer, G., M. Peleg, Journal of Texture Studies, 17(1): 61-70 (1986)), a viscosity synergism index Iᵥ(\dot{γ}), used to quantify viscous synergism in our mixed polymers system, is defined by the following formula:

$${I}_{v} ( \dot{γ} ) = \frac{{η}_{i + j} ( \dot{γ} )}{{η}_{i} ( \dot{γ} ) + {η}_{j} ( \dot{γ} )} \qquad ( 3 )$$

where ηᵢ(\dot{γ}), ηⱼ(\dot{γ}), and ηᵢ₊ⱼ(\dot{γ}) are the steady shear viscosities corresponding to components i, j, and i+j at concentrations cᵢ, cⱼ and, cᵢ₊ⱼ=cᵢ+cⱼ respectively. According to this definition, when I_{V}(\dot{γ})>1, the viscosity of the mixed system would be larger than the algebraic sum of its components' viscosities (i.e., synergism would result). The magnitude of Iᵥ(\dot{γ}) reflects the degree of viscous synergism that varies with compositions of the mixed polysaccharide solutions and shear rates.

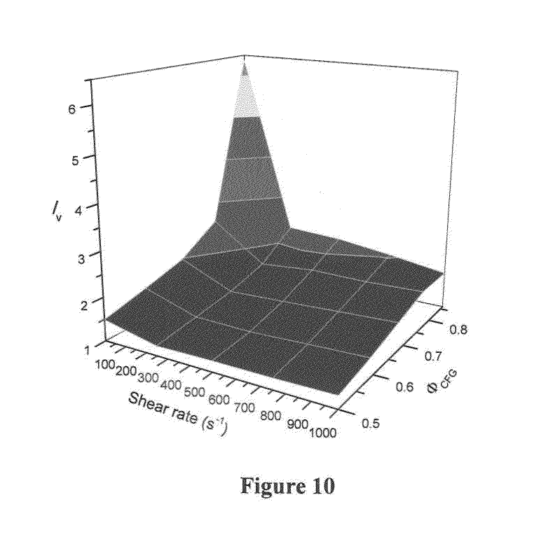

The steady shear viscosities and corresponding viscosity synergism index calculated using equation (3) for the solutions of two individual component (ηᵢ(\dot{γ}) and ηⱼ(\dot{γ})) and their mixed solutions (ηᵢ₊ⱼ(\dot{γ})), with various weight fractions (Φ_{CFG}) of CFG under different shear rates, are given in Table 4. There was fluctuation of viscosity readings of pure CFG solutions due to measurement difficulty at such low shear fate for very low viscous solutions. But it could be noted from Table 4 that the viscosities of all pure CFG solutions were much lower than HA solution, therefore the calculated Iᵥ would be very close to the actual value with limited deviation. Accordingly, FIG. 10 shows the change of Iᵥ with shear rate and CFG compositions (expressed in term of the Φ_{CFG}) of the mixed HA/CFG solutions. As seen in Table 4, the values of (ηᵢ₊ⱼ(\dot{γ})) were higher than those of ηᵢ(\dot{γ})+ηⱼ(\dot{γ}) for all polysaccharide solutions investigated at any fixed shear rate or composition. The value of Iᵥ increased with increase of Φ_{CFG} and decrease of shear rate. FIG. 10 also shows that a significant enhancement of synergistic effect occurred at low shear rates and high ratio of CFG to HA. These experimental results clearly indicated that the viscosity synergism can be easily controlled by changing Φ_{CFG}. In other words, the synergistic effect between the HA and CFG components can be effectively modulated by the composition of the mixed polymers system and the applied shear rate.

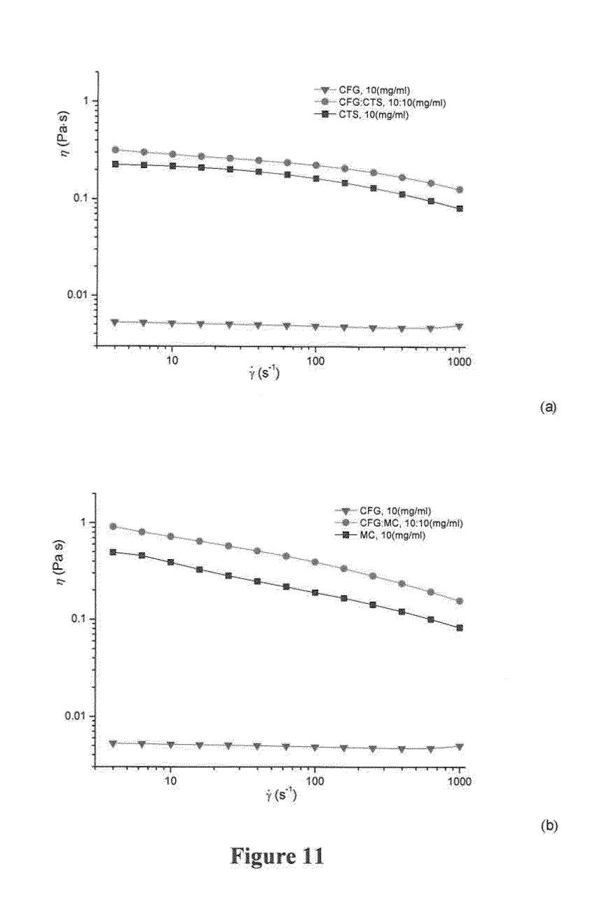

A similar viscous synergism was also observed in the aqueous mixtures of CFG/CTS and CFG/MC as shown in FIGS. 11(a) and (b) respectively. The synergistic effect of CFG did not look closely related to the ionic or non-ionic features and chemical structures of all three kinds of added polysaccharides (i.e., anionic, cationic and neutral) as they had a similar effect with a slight difference in the degree of synergism. For example, the viscous synergism index (Iᵥ) of CFG mixture (10:10 mg/mL) with cationic (CTS) and neutral (MC) polymers at a shear rate JO s⁻¹ were 1.287 and 1.835 respectively. Similarly, the synergism index of CFG mixture (10:10 mg/mL) with uncharged MC polymer (Iᵥ=1.835) was higher than its mixture with an anionic and higher molecular weight HA polymer (Iᵥ=1.276, Table 4) at the same shear rate 10 s⁻. The mode of intermolecular interaction between CFG/CTS and CFG/MC resulting synergism was more likely similar to the model proposed for CFG/HA in FIG. 9. It should also be noted that the electrostatic repulsion between CFG and anionic polymer HA, and the steric repulsion resulting from the high branches on CFG backbone were more likely not the barrier for the interaction between these two polysaccharides main chains. Due to a very low content of glucuronic acid in CFG, a possibility of its electrostatic attraction with the cationic CTS to enhance the degree of viscous synergism can be easily ruled out. Furthermore, in such a hydrophilic macromolecule, hydrophobicity may not bethought of as a driving force fonts interaction with another high molecular weight polymers. So the hydrogen bonding between CFG and all three kinds of additive polysaccharides can be proposed as the predominant driving force for the viscous synergism in their mixed solutions.

### CONCLUSIONS

We have surprisingly demonstrated that CFG had a very remarkable viscous synergism effect when mixed with either anionic HA), cationic (e.g., CTS), or neutral (e.g., MC) polysaccharides in an aqueous solution. Hydrogen bonding between CFG and all three kinds of additive was proposed as the predominant driving force for such viscous synergism effect. The degree of viscous synergism increased not only with the increase of CFG concentration but also with the decrease of rate in the mixed polysaccharides solution.

All of the references cited herein, including U.S. patents, are incorporated by reference in their entirety. Also incorporated by reference in their entirety are the following references: Donati, I., et al., Biomacromolecules, 8(3): 957-962 (2007); Kaletunc-Gencer, G., et al., Journal of Texture Studies, 17(1): 61-70 (1986); Khouryieh, et al., Journal of Food Science, 72(3): C173-C181 (2007), Li, X. B., et al., Food Hydrocolloids, 23(8): 2394-2402 (2009); McCleary, B. B., Carbohydrate Research, 71(1): 205-230 (1979); Miyoshi, E., et al., Journal of Agricultural and Food Chemistry, 44(9): 2486-2495 (1996); orris; V. J., et al., Current Opinion in Colloid & Interface Science, 2(6): 567-572 (1997)); Pellicer, J., et al., Food Science and Technology International, 6(5): 415-423 (2000); Rojas, M. R., et al., Journal of Colloid and Interface Science, 322(1): 65-72 (2008); Sanchez, C., et al., Food Hydrocolloids, 16(3): 257-267 (2002); Sendijarevic, L, and A. J. McHugh, Macromolecules, 33(2): 590-596 (2000); Sovilj, V., and L. Petrovic, Colloids and Surfaces a-Physicochemical and Engineering Aspects, 298(1-2): 94-98 (2007); Williams, P. A., and G. O. Phillips, Gum Arabic, In Handbook of hydrocolloids; G. O. Phillips and P. A. Williams, pp. 155-168), 2000, CRC Press, Boca Raton, Fla.; Wu, Y., et al., Carbohydrate Polymers, 78(1): 112-116 (2009)); Yasar, K., et al., Food Hydrocolloids, 23(5): 1305-1311 (2009); Zhang, L. M., and J. F. Zhou, Colloids and Surfaces a-Physicochemical and Engineering Aspects, 279(1-3): 34-39 (2006).

Thus, in view of the above, disclosed (in part) is the following:

A composition comprising (or consisting essentially of or consisting of) about 1 wt % to about 99 wt % corn fiber gum and about 99 wt % to about 1 wt % polymer thickener. The composition comprising about 50 wt % to about 90 wt % corn fiber gum and about 50 wt % to about 10 wt % polymer thickener.

The above composition, wherein the polymer thickener is selected from the group consisting of anionic polysaccharides, cationic polysaccharides, neutral polysaccharides, and mixtures thereof.

The above composition, wherein said anionic polysaccharides are selected from the group consisting of hyaluronan, sodium alginate, pectin, carrageenan, xanthan gum, chondroitin sulfate, gum arabic, gum karaya, gum tragacanth, sodium carboxymethylcellulose, and mixtures thereof.

The above composition, wherein said cationic polysaccharides are selected from the group consisting of chitosan, cationic guar gum, cationic hydroxyethylcellulose, and mixtures thereof.

The above composition, wherein said neutral polysaccharides are selected from the group consisting of methyl cellulose, guar gum, locust bean gum, konjac gum, agarose, starch, ethyl cellulose, hydroxyl ethyl cellulose, hydroxypropyl cellulose, methyl hydroxyl ethyl cellulose, methyl hydroxypropyl cellulose, and mixtures thereof.

The above composition, wherein said polymer thickener is selected from the group consisting of hyaluronan, chitosan, methylcellulose; and mixtures thereof.

Other embodiments of the invention will be apparent to those skilled in the art froth a consideration of this specification or practice of the invention disclosed herein. It is intended that the specification and examples be considered as exemplary only, with the true scope and spirit of the invention being indicated by the following claims.

TABLE 1

| Sample | 10⁻⁵ M_{w} | M_{w}/Mₙ | R_{g, z} (nm) | [η] (mL/g) | α |
|---|---|---|---|---|---|
| CFG | 3.33 | 5.20 | 23.7 | 148.2 | 0.471 |
| HA-R | 3.56 | 1.53 | 80.5 | 878.4 | 0.686 |
| HA | 12.9 | 2.16 | 119.5 | 1288.6 | 0.601 |

TABLE 2

| Samples | K (Pa sⁿ) | n | R² |
|---|---|---|---|
| Component solutions: | | | |
| HA, 10 (mg/mL) | 5.525 | 0.445 | 0.994 |
| CFG, 10 (mg/mL) | 0.005 | 0.974 | 0.996 |
| CFG, 30 (mg/mL) | 0.033 | 0.935 | 0.997 |
| CFG, 60 (mg/mL) | 0.215 | 0.920 | 0.998 |
| Mixed solutions | | | |
| CFG:HA, 10:10 (mg/mL), | 7.573 | 0.422 | 0.997 |
| Φ_{CFG} = 0.50 | | | |
| CFG:HA, 30:10 (mg/mL), | 10.086 | 0.426 | 0.999 |
| Φ_{CFG} = 0.75 | | | |
| CFG:HA, 60:10 (mg/mL), | 14.375 | 0.444 | 1.000 |
| Φ_{CFG} = 0.86 | | | |

TABLE 3

| Sample solutions | η₀ (Pa s) | λ (s) | p | γₒ (s⁻¹) | R² |
|---|---|---|---|---|---|
| HA, 10 (mg/mL) | 5.277 | 0.278 | 0.829 | 3.597 | 1.000 |
| Mixtures | | | | | |
| CFG:HA, 10:10, | 7.981 | 0.373 | 0.823 | 2.681 | 1.000 |
| Φ_{CFG} = 0.50 | | | | | |
| CFG:HA, 30:10, | 13.767 | 0.687 | 0.7296 | 1.456 | 1.000 |
| Φ_{CFG} = 0.75 | | | | | |
| CFG:HA, 60:10, | 41.409 | 2.326 | 0.665 | 0.43 | 1.000 |
| Φ_{CFG} = 0.86 | | | | | |

TABLE 4

| | Mixed solutions | | | Individual solutions | | | |
|---|---|---|---|---|---|---|---|
| | CFG:HA | CFG:HA | CFG:HA | CFG | CFG | CFG | HA |
| Steady shear | 10:10 (mg/mL), | 30:10 (mg/mL), | 60:10 (mg/mL), | 10 (mg/mL), | 30 (mg/mL), | 60 (mg/mL), | 10 (mg/mL), |
| viscosities (Pa s) | Φ_{CFG} = 0.5 | Φ_{CFG} = 0.75 | Φ_{CFG} = 0.86 | ηⱼ(γ) | ηⱼ(γ) | ηⱼ(γ) | ηⱼ(γ) |
| γ = 0.0398 s⁻¹ | | | | 0.0315 | 0.04442 | 0.3028 | 5.178 |
| ηᵢ₊ⱼ(γ) | 7.776 | 12.88 | 34.87 | — | — | — | — |
| ηᵢ(γ) + ηⱼ(γ) | 5.210 | 5.222 | 5.481 | — | — | — | — |
| [symbol] (γ) | 1.493 | 2.466 | 6.362 | — | — | — | — |
| γ = 0.1 s⁻¹ | | | | 0.01216 | 0.04576 | 0.2694 | 5.091 |
| ηᵢ₊ⱼ(γ) | 7.586 | 12.120 | 29.860 | — | — | — | — |
| ηᵢ(γ) + ηⱼ(γ) | 5.103 | 5.137 | 5.360 | — | — | — | — |
| [symbol] (γ) | 1.487 | 2.359 | 5.570 | — | — | — | — |
| γ = 0.3981 s⁻¹ | | | | 0.00681 | 0.03629 | 0.2326 | 4.615 |
| ηᵢ₊ⱼ(γ) | 6.664 | 9.918 | 21.180 | — | — | — | — |
| ηᵢ(γ) + ηⱼ(γ) | 4.622 | 4.651 | 4.848 | — | — | — | — |
| [symbol] (γ) | 1.442 | 2.132 | 4.369 | — | — | — | — |
| γ = 1 s⁻¹ | | | | 0.00576 | 0.03395 | 0.2138 | 3.899 |
| ηᵢ₊ⱼ(γ) | 5.494 | 7.804 | 15.280 | — | — | — | — |
| ηᵢ(γ) + ηⱼ(γ) | 3.905 | 3.933 | 4.113 | — | — | — | — |
| [symbol] (γ) | 1.407 | 1.984 | 3.715 | — | — | — | — |
| γ = 3.981 s⁻¹ | | | | 0.0053 | 0.03014 | 0.1915 | 2.516 |
| ηᵢ₊ⱼ(γ) | 3.358 | 4.517 | 7.806 | — | — | — | — |
| ηᵢ(γ) + ηⱼ(γ) | 2.521 | 2.546 | 2.708 | — | — | — | — |
| [symbol] (γ) | 1.332 | 1.774 | 2.883 | — | — | — | — |
| γ = 10 s⁻¹ | | | | 0.00516 | 0.02816 | 0.1785 | 1.649 |
| ηᵢ₊ⱼ(γ) | 2.111 | 2.789 | 4.789 | — | — | — | — |
| ηᵢ(γ) + ηⱼ(γ) | 1.654 | 1.677 | 1.828 | — | — | — | — |
| [symbol] (γ) | 1.276 | 1.663 | 2.621 | — | — | — | — |
| γ = 39.81 s⁻¹ | | | | 0.00501 | 0.02565 | 0.1611 | 0.7174 |
| ηᵢ₊ⱼ(γ) | 0.896 | 1.199 | 2.151 | — | — | — | — |
| ηᵢ(γ) + ηⱼ(γ) | 0.722 | 0.743 | 0.879 | — | — | — | — |
| [symbol] (γ) | 1.241 | 1.614 | 2.448 | — | — | — | — |
| γ = 100 s⁻¹ | | | | 0.00488 | 0.0242 | 0.1494 | 0.3792 |
| ηᵢ₊ⱼ(γ) | 0.472 | 0.661 | 1.266 | — | — | — | — |
| ηᵢ(γ) + ηⱼ(γ) | 0.384 | 0.403 | 0.529 | — | — | — | — |
| [symbol] (γ) | 1.230 | 1.638 | 2.395 | — | — | — | — |
| γ = 398.1 s⁻¹ | | | | 0.00469 | 0.02238 | 0.1301 | 0.1371 |
| ηᵢ₊ⱼ(γ) | 0.178 | 0.283 | 0.601 | — | — | — | — |
| ηᵢ(γ) + ηⱼ(γ) | 0.142 | 0.159 | 0.267 | — | — | — | — |
| [symbol] (γ) | 1.256 | 1.775 | 2.249 | — | — | — | — |
| γ = 1000 s⁻¹ | | | | 0.00499 | 0.02118 | 0.1145 | 0.06996 |
| ηᵢ₊ⱼ(γ) | 0.096 | 0.170 | 0.338 | — | — | — | — |
| ηᵢ(γ) + ηⱼ(γ) | 0.075 | 0.091 | 0.184 | — | — | — | — |
| [symbol] (γ) | 1.277 | 1.861 | 1.835 | — | — | — | — |

[symbol]

indicates data missing or illegible when filed

We claim:

1. A composition comprising about 1 wt % to about 99 wt % corn fiber gum and about 99 wt % to about 1 wt % polymer thickener.

2. The composition according to claim 1, comprising about 50 wt % to about 90 wt % corn fiber gum and about 50 wt % to about 10 wt % polymer thickener.

3. The composition according to claim 1, wherein said polymer thickener is selected from the group consisting of anionic polysaccharides, cationic polysaccharides, neutral polysaccharides, and mixtures thereof.

4. The composition according to claim 1, wherein said polymer thickener is selected from the group consisting of hyaluronan, chitosan, methylcellulose, and mixtures thereof.

5. The composition according, to claim 3, wherein said anionic polysaccharides are selected from the group consisting of hyaluronan, sodium alginate, pectin, carrageenan, xanthan gum, chondroitin sulfate, gum arabic, gum, karaya, gum tragacanth, sodium carboxymethylcellulose, and mixtures thereof.

6. The composition according to claim 3, wherein said cationic polysaccharides are selected from the group consisting of chitosan, cationic guar gum, cationic hydroxyethylcellulose, and mixtures thereof.

7. The composition according to claim 3, wherein said neutral polysaccharides are selected from the group consisting of methyl cellulose, guar gum, locust bean gum, konjac gum, agarose, starch, ethyl cellulose, hydroxyl ethyl cellulose, hydroxypropyl cellulose, methyl hydroxyl ethyl cellulose, methyl hydroxypropyl cellulose, and mixtures thereof.
